(19) United States
(12) Patent Application Publication
(10) Pub. No.: US 2005/0281517 A1
(43) Pub. Date: Dec. 22, 2005

(54) Multi-layered buffer tube for optical fiber cable

(76) Inventors: Robert A. Wessels JR., Hickory, NC (US); Robert Brian Franklin, Taylorsville, NC (US)

Correspondence Address: James R. Cannon;Myers Bigel Sibley & Sajovec, P.A., P.O. Box 37428, Raleigh, NC, 27627, US

(21) Appl. No.: 10/872,226

(22) Filed: Jun. 18, 2004

(51) Int. Cl. G02B 6/44

(52) U.S. Cl. 385/109; 385/100; 385/110; 385/112; 385/113

(57) ABSTRACT

A multi-layer buffer tube for a fiber optic cable comprises: a radially inward first layer formed into an elongate cylinder, the first layer being formed of a first polymeric material; and a radially outward second layer formed into an elongate cylinder that circumferentially overlies the radially inner layer, the second layer being formed of a second polymeric material that differs from the second material. In this configuration, the buffer tube can be formed of materials that can provide the benefits associated with those materials, and the combination of materials can compensate for some of the shortcomings of the materials when used alone.

### FIELD OF THE INVENTION

The present invention relates generally to fiber optic cable, and more specifically to buffer tubes for fiber optic cable.

### BACKGROUND OF THE INVENTION

Fiber optic cables include optical fibers that transmit information in cable television, computer, power, and telephone systems. Optical fibers are relatively fragile and should be protected during the manufacture, handling and installation of cables. A variety of protective measures are often provided in cables containing optical fibers. For example, to allow the cable to move or be flexed a certain degree by external forces or by thermal expansion and contraction without stressing or microbending the optical fibers, the optical fiber or fibers are typically enclosed in a plastic buffer tube having a bore of a cross-sectional area larger than the cross-sectional area of the fiber or fibers within it. This is referred to as a “loose” configuration.

A “loose-tube” optical fiber cable may include one or several buffer tubes, each containing one or a plurality of optical fibers. The plurality of optical fibers may be in the form of individual fibers, an optical fiber ribbon or a stack of optical fiber ribbons. Often, when a single buffer tube is employed (a “central tube” cable), strength members extending the length of the cable are embedded in the buffer tube or outer jacket (see, e.g., U.S. Pat. No. 6,377,738 to Anderson et al.). When multiple buffer tubes are employed (a “stranded loose tube” cable), they are typically arranged about a central strength member (see, e.g., U.S. Pat. No. 6,411,403 to Siddhamalli).

In either instance, it is typically desirable that the material of the buffer tube(s) have a relatively high Young's modulus, which can provide the buffer tube with high tensile and compressive resistance. Also, the material should have a relatively low coefficient of thermal expansion. It is also generally desirable that the buffer tube have a relatively low weight. Typical materials for use in buffer tubes include polybutyl terephthalate (PBT), nylon, polyethylene (PE), and polypropylene (PP). Unfortunately, each of these materials has some inherent disadvantages. For example, PBT can be susceptible to hydrolysis that leads to a loss in strength, too rigid for some applications, and relatively expensive. Nylon tends to lack resistance to hydrolysis and is susceptible to water absorption, which can adversely affect optical and mechanical properties and dimensional stability. Although it tends to be a lower cost material, PE alone has poor thermal and mechanical properties and typically requires a significant amount of filler material. PP shrinks significantly after processing, which can negatively impact excess fiber length, and may also require significant filler material.

Copolymers and blends have also been used in buffer tubes. For example, a PE/PP copolymer employed for some buffer tubes is typically produced with a nucleating additive to reduce its thermal expansion coefficient. However, the copolymer maintains some of the negative performance and processing properties of the individual polymers. Also, a blend of nylon-6 and polyethylene has been proposed (see Siddhamalli, sura).

The foregoing demonstrates the desirability of continuing to search for additional materials for use in buffer tubes.

### SUMMARY OF THE INVENTION

The present invention can address some of the shortcomings of prior buffer tubes. As a first aspect, the present invention is directed to a multi-layer buffer tube for a fiber optic cable. More specifically, the inventive buffer tubes comprises: a radially inward first layer formed into an elongate cylinder, the first layer being formed of a first polymeric material; and a radially outward second layer formed into an elongate cylinder that circumferentially overlies the radially inner layer, the second layer being formed of a second polymeric material that differs from the second material. In this configuration, the buffer tube can be formed of materials that can provide the benefits associated with those materials, and the combination of materials can compensate for some of the shortcomings of the materials when used alone.

In one embodiment, the first material (i.e., the material of the inner layer of the buffer tube) has a lower coefficient of thermal expansion than the second material (for example, the first material may be selected from the group consisting of PBT, nylon and PC, with PBT being preferred, and the second material may be a polyolefin, preferably PE and more preferably foamed PE). In another embodiment, the first and second materials are reversed from those listed above, with the first material having a higher coefficient of thermal expansion than the second material, such that a polyolefin may be the first material and PBT, nylon or PC may be the second material. In an additional embodiment, the buffer tube includes a third layer over the second layer formed of a third material; an example of this embodiment has (proceeding radially outwardly from the center) a layer of PBT, nylon or PC, a layer of foamed PE, and a layer of solid PBT, PC, nylon or polyolefin.

As a second aspect, the present invention is directed to a fiber optic cable. The inventive cable includes at least one buffer tube of the type described above and at least one optical fiber positioned within the buffer tube.

As a third aspect, the present invention is directed to a method of forming a fiber optic cable. The method includes the steps of: providing at least one optical fiber; extruding a first layer comprising a first polymeric material to circumferentially surround the optical fiber; and extruding a second layer comprising a second polymeric material to circumferentially surround the first layer.

### BRIEF DESCRIPTION OF THE DRAWINGS

FIG. 1 is a cross-sectional view of a stranded loose tube fiber optic cable of the present invention.

FIG. 2 is a cross-sectional view of a central loose tube fiber optic cable of the present invention.

FIG. 3 is an enlarged section view of the buffer tube of the cable of FIG. 1.

FIG. 4 is a section view of an alternative embodiment of a buffer tube of the present invention.

FIG. 5 is a section view of another alternative embodiment of a buffer tube of the present invention.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

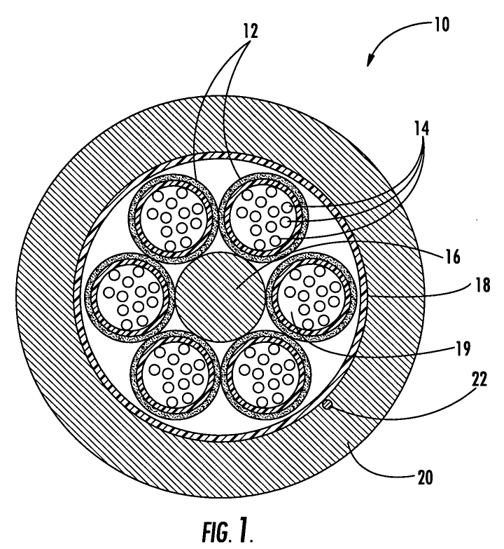

Referring now to FIG. 1, a stranded loose tube cable, designated broadly at 10, is illustrated therein. The cable 10 includes a plurality of buffer tubes 12, each of which houses multiple optical fibers 14, stranded about a central strength member 16. A core wrap 18 may be wrapped around the buffer tube 14. A protective outer jacket 20 is disposed over the core wrap 18. An optional ripcord 22 is provided near the interface of the wrap 18 and the outer jacket 20. Water-blocking gel 19 or other water-blocking material is typically disposed within the buffer tubes 12, and may also be disposed on the exterior of the buffer tubes 14, within the core wrap 18, if desired. These components are described in greater detail below.

The optical fibers 14 are long, slender strands that are capable of carrying and propagating an optical signal. More particularly, optical fibers serve as a medium for transmitting light by virtue of a phenomenon known as total internal reflection. Optical fibers typically have a glass or, on occasion, plastic core that is enveloped by an outer concentric shell or cladding. The cladding is generally made from glass and has a relatively low index of refraction with respect to the core. Because of the difference in the index of refraction between the two materials, light rays striking the cladding at an angle greater than or equal to a critical angle (φ_{c}) will be reflected back into the core at an angle of reflection equal to the angle of incidence. In as much as the angles of incidence and reflection are equal, the light ray will continue to zig-zag down the length of the fiber. If a light ray strikes the cladding at an angle less than the critical angle, however, the ray will be refracted and pass through the cladding, thus escaping the fiber.

Those skilled in this art will recognize that any number of optical fiber constructions may be suitable for use with the present invention. In particular, optical fibers having a thickness between about 200 and 300 microns are preferred. Other desirable physical and performance properties include those exhibited by single mode fibers with zero water peak (ZWP), which allow transmission in the E band (1360-1460 nm), and high bandwidth multimode fibers. Exemplary optical fibers are “LightScope” ZWP Single Mode or “LaserCore” multimode optical fibers, available from CommScope Inc., Hickory N.C.

Referring again to FIG. 1, the central strength member 16 provides rigidity to the cable 10. The strength member 16 is typically formed of a dielectric material such as glass-reinforced plastic, or may be formed of a metallic material such as steel. The strength member 16 may also include a polymeric coating in some embodiments.

Referring once again to FIG. 1, the water-blocking gel 19 can have water-blocking properties and can reduce the degree of movement of optical fibers 14 within the buffer tube lumen. An exemplary filling gel is one comprising a blend of oil and fumed silica; such a gel is available from Master Adhesives (Norcross, Ga.). In other embodiments, other water-blocking materials, such as dry powders or threads, may be employed in lieu of a filling gel. An exemplary dry powder is disclosed in U.S. Pat. No. 6,326,551 to Adams.

Referring again to FIG. 1 and also to FIG. 3, at least one, and preferably all, of the buffer tubes 12 of the cable 10 are of a multi-layer construction. More specifically, the buffer tubes 12 include an inner layer 25 formed of a first polymeric material and an outer layer 26 formed of a second polymeric material that differs from the first polymeric material. In a multi-layer construction such as that of the buffer tubes 12, the multi-layer buffer tubes 12 can provide satisfactory performance while addressing some of the shortcomings observed in prior art buffer tubes of unitary, single-material construction.

In the embodiment illustrated in FIG. 3, the inner layer 25 of the buffer tube 12 comprises PBT, and the outer layer 26 comprises PE (typically MDPE or HDPE). The PBT of the inner layer 25, which has a lower thermal expansion coefficient than does PE, can significantly influence the thermal expansion coefficient of the entire buffer tube 12 such that it is acceptable for use in buffer tubes. Also, the PBT of the inner layer 25 can provide crush resistance to the buffer tube 25. Typically, a PBT material suitable for use with the present invention has a Young's modulus of between about 300,000 and 400,000 psi and a coefficient of thermal expansion of between about 4.8×10⁻⁵ and 6.6×10⁻⁵ in/in-° F. An exemplary PBT material is Valox PBT, available from GE Plastics, New York City, N.Y. The inner layer 25 is typically between about 0.012 and 0.028 inches in thickness when used in the buffer tube 12.

Those skilled in this art will recognize that other materials may be employed in the inner layer 25 of the buffer tube 12. For example, PC and nylon may also be employed. If these materials are used, care should be taken in selecting materials that have rigidity, crush resistance and thermal expansion characteristics that somewhat resemble those of PBT.

Referring again to FIG. 3, the PE comprising the outer layer 26 of the buffer tube 12 typically has a lower Young's modulus than does the PBT, consequently reducing the overall rigidity of the buffer tube 12, consequently improving handling of the cable 10. Because the PBT of the inner layer 25 can help to provide the necessary crush resistance for the buffer tube 12, the level and type of filling materials typically employed with PE alone may be reduced or, in some instances, eliminated. Also, foaming of the PE of the outer layer 26 can reduce weight without a considerable reduction in strength (exemplary foaming techniques are discussed in U.S. Pat. No. 6,037,545 to Fox et al. and U.S. Pat. Nos. 5,959,245 and 6,137,058 to Moe et al.). Moreover, the use of PE, which is typically less expensive than PBT, can reduce the overall material cost of the buffer tube 12.

Typically, a PE material employed in the outer layer 26 has a Young's modulus of between about 130,000 and 140,000 psi, and a coefficient of thermal expansion of between about 70×10⁻⁶ and 110×⁻⁶ in/in-° F. When PE is employed in the outer layer 26, the outer layer 26 is typically between about 0.012 and 0.028 inches in thickness. An exemplary PE material is resin 3845, available from Dow Chemical, Midland, Mich.

Those skilled in this art will recognize that other materials may be employed in the outer layer 26 of the buffer tube 12. For example, another polyolefin, such as PP, may be employed, as may a PE/PP blend. In many instances, the material comprising the outer layer 26 will include additives, such as antioxidants and other stabilizers, that can maintain the integrity of the polymer over time, and fillers, such as sodium benzoate, that can impact the mechanical properties of the polymer.

In the illustrated embodiment and with other stranded loose tube fiber optic cables, the inner diameter of the entire buffer tube 12 is typically between about 0.060 and 0.090 inches, and the outer diameter is typically between about 0.080 and 0.120 inches. Also, although it is preferred that all of the buffer tubes 12 of the cable 10 be identical multi-layer tubes, those skilled in this art will appreciate that some of the buffer tubes of a given cable may be conventional single layer tubes, and/or that some of the buffer tubes may have different multi-layer constructions, with variations in material, layer thickness, and the like.

The multi-layer buffer tubes 12 can be formed in any manner known to those skilled in this art to be suitable for the manufacture of elongate polymeric tubes. Preferably, the buffer tubes 12 are formed by extruding the inner layer 25 over the optical fibers 14 and any water-blocking material 19, then extruding the outer layer 26 over the inner layer 25. These extrusion steps can be performed separately or as part of a co-extrusion process.

Referring back to FIG. 1 and continuing the discussion of the components of the cable 10, the core wrap 18 typically comprises circumferentially-wrapped yarns that are formed of aramid, polyethylene, polyester, or fiberglass materials. Alternatively, the core wrap 18 may include longitudinal tapes that may include water swellable materials designed to block water flow in the cable in the event the outer jacket is breached.

The outer jacket 20 is formed of a polymeric material. Exemplary polymeric materials include polyvinylidene fluoride, polyethylene, polyvinylchloride, and copolymers and blends thereof; a medium density polyethylene material is preferred in some embodiments. The material for the jacket 20 should be capable of protecting the internal components from external elements (such as water, dirt, dust and fire) and from physical abuse. The material of the jacket 20 may include additives, such as PTFE or carbon black, which can enhance physical properties or facilitate manufacturing. Ordinarily, the jacket 20 has a thickness of between about 0.020 and 0.070 inches. In some embodiments, the jacket 20 is bonded to the core wrap 18 with an adhesive (not shown); exemplary adhesives include ethylene acrylic acid (EAA), ethylene methylacrylate (EMA) and mixtures and formulations thereof Typically, the jacket 20 is formed onto the core wrap 18 through an extrusion process.

An exemplary cable 10 can be constructed according to Table 1 below.

TABLE 1

| Component | Material | Diameter (in.) |
|---|---|---|
| Optical Fiber | Glass | 0.010 |
| Strength Member | GRP | 0.125 |
| Buffer Tubes | PBT/PE | 0.118 |
| Inner Layer | PBT (0.007 in. thick) | 0.345 |
| Outer Layer | Foamed PE (0.013 in. | 0.360 |
| | thick) | |
| Core Wrap | Water Swellable Matrix | 0.370 |
| Jacket | Polyethylene (0.060 in. | 0.490 |
| | thick) | |

A cable 10 as described has the performance properties set forth in Table 2.

TABLE 2

| Property | Value |
|---|---|
| Crush Resistance | ≧44 N/m |
| Operating Temperature | −40° C. to +70° C. |
| Attenuation | .35/.25 dB/km at 1310/1550 nm |
| | wavelength |

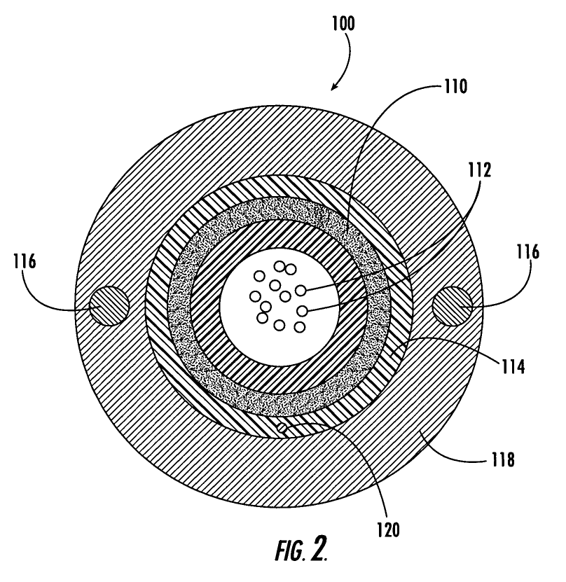

Multi-layer buffer tubes of the present invention may also be employed in central tube cable, an example of which is illustrated herein at FIG. 2 and designated broadly at 100. The cable 100 includes a multi-layer buffer tube 110 that contains a plurality of optical fibers 112. Radial strength yarns 114, made from, for example, aramid, polyethylene, polyester, or fiberglass materials, are contra-helically stranded around the buffer tube 110; these yarns may be impregnated with flooding compounds (such as a petroleum based hot melt filling compound manufactured by Witco or Amoco), or protected by water swellable yarn or tape. Two strength members 116 are located 180 degrees apart on the outside of the radial strength yarns 114. An outer jacket 118 encapsulates the strength members 116 and radial strength yarns 114 to complete the structure. A high strength ripcord 120 is applied over the radial strength yarns 114 to aid in removal of the jacket 120.

In this embodiment, the buffer tube 110 may have the same general construction as the buffer tube 12 described above, and may be formed of the same materials, but will likely have different dimensions. For example, the buffer tube 110 will typically have an inner diameter of between about 0.080 and 0.250 inches and an outer diameter of between about 0.118 and 0.250 inches, with its inner layer 110a of PBT having a thickness of between about 0.005 and 0.025 inches and its outer layer 110b of foamed PE having a thickness of between about 0.010 and 0.030 inches.

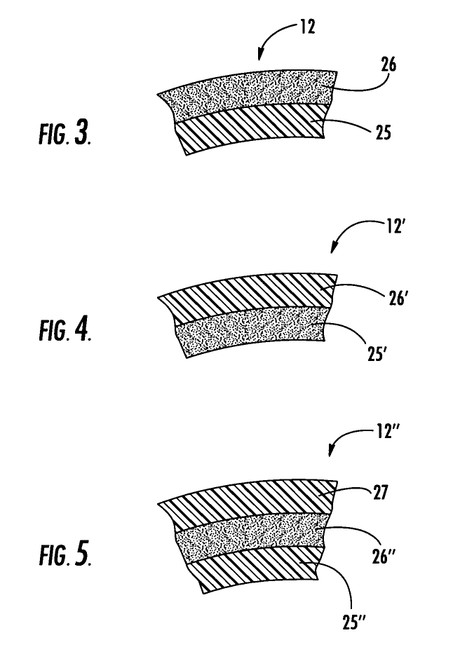

Alternative embodiments of the multi-layer buffer tubes 12, 110 are illustrated in FIGS. 4 and 5. In the embodiment illustrated in FIG. 4, the buffer tube 12′ has an inner layer 25′ and an outer layer 26′, wherein the inner layer 25′ is formed of the polyolefin materials described above for the outer layer 26 of FIG. 3 (preferably a foamed material), and the outer layer 26′ is formed of the materials set forth above for the inner layer 25 of FIG. 3. In this configuration, it is preferred that the inner layer 25′ have a thickness of between about 0.010 and 0.030 inches and the outer layer 26′ have a thickness of between about 0.005 and 0.025 inches.

In the buffer tube embodiment illustrated in FIG. 5, the buffer tube 12″ has an inner layer 25″, an intermediate layer 26″, and an outer layer 27. Any of the materials described above may be used in these layers, although adjacent layers should be formed of different materials. Thus, in one embodiment, the inner layer 25″ is formed of PBT, PC or nylon (with PBT being preferred), the intermediate layer 26″ is formed of foamed polyolefin, and the outer layer 27 is formed of solid PBT, PP or PE. As a typical example, a buffer tube 12″ with an inner diameter of ______ and an outer diameter of ______ suitable for use in a stranded loose tube cable may be constructed as shown in Table 3 below.

TABLE 3

| | Material | Thickness (in.) |
|---|---|---|
| Inner Layer | PBT | 0.005 |
| Intermediate Layer | Foamed PE | 0.010 |
| Outer Layer | PBT | 0.005 |

As another example, a buffer tube 12″ with an inner diameter of 0.110 inches and an outer diameter of 0.160 inches suitable for use in a central tube cable such as that shown in FIG. 2 may be constructed as set forth in Table 4 below.

TABLE 4

| | Material | Thickness (in.) |
|---|---|---|
| Inner Layer | PBT | 0.005 |
| Intermediate Layer | Foamed PE | 0.013 |
| Outer Layer | PBT | 0.007 |

The three layer buffer tube 12″ can provide some of the same performance and manufacturing advantages as are listed above for two layer constructions.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as recited in the claims. The invention is defined by the following claims, with equivalents of the claims to be included therein.

1. A fiber optic cable, comprising:
a plurality of buffer tubes, at least one of the buffer tubes including therein an optical fiber in a loose configuration, the at least one buffer tube comprising:
a radially inward first layer formed into an elongate cylinder, the first layer being formed of a first polymeric material; and
a radially outward second layer formed into an elongate cylinder that circumferentially overlies the radially inner layer, the second layer being formed of a second polymeric material that differs from the first material;
wherein at least one of the first and second layers is foamed:
the fiber optic cable further comprising:
a central strength member positioned within the plurality of buffer tubes; and
an outer jacket surrounding the strength member and the plurality of buffer tubes.

2. The fiber optic cable defined in claim 1, wherein the first material has a first coefficient of thermal expansion, and the second material has a second coefficient of thermal expansion that differ from the first coefficient of thermal expansion.

3. The fiber optic cable defined in claim 2, wherein the second coefficient of thermal expansion is higher than the first coefficient of thermal expansion.

4. (canceled)

5. The fiber optic cable defined in claim 1, wherein the first layer is foamed.

6. The fiber optic cable defined in claim 1, wherein the second layer is foamed.

7. The fiber optic cable defined in claim 1, wherein the second layer is the outermost layer of the buffer tube.

8. The tube fiber optic cable defined in claim 7, wherein the first material is selected from the group consisting of: polybutyl terephthalate; polycarbonate; and nylon.

9. The fiber optic cable defined in claim 8, wherein the first material comprises polybutyl terephthalate.

10. The fiber optic cable defined in claim 8, wherein the second material comprises a polyolefin.

11. The fiber optic cable defined in claim 7, wherein the second material is selected from the group consisting of: polybutyl terephthalate; polycarbonate; and nylon.

12. The fiber optic cable defined in claim 7, wherein the second material comprises polybutyl terephthalate.

13. The fiber optic cable defined in claim 11, wherein the first material comprises a polyolefin.

14. The fiber optic cable defined in claim 7, wherein the first material comprises polybutyl terephthalate, and the second material comprises polyolefin.

15. The fiber optic cable defined in claim 1, further comprising a third layer that circumferentially surrounds the second layer.

16. The fiber optic cable defined in claim 15, wherein the first material is selected from the group consisting of: polybutyl terephthalate; polycarbonate; and nylon.

17. The fiber optic cable defined in claim 15, wherein the first material comprises polybutyl terephthalate.

18. The fiber optic cable defined in claim 15, wherein the second material comprises a polyolefin.

19. The fiber optic cable defined in claim 15, wherein the third material is selected from the group consisting of: polybutyl terephthalate; polycarbonate; nylon; and polyolefin.

20. A fiber optic cable, comprising:
a buffer tube comprising:
a radially inward first layer formed into an elongate cylinder, the first layer being formed of a first polymeric material; and
a radially outward second layer formed into an elongate cylinder that circumferentially overlies the radially inner layer, the second layer being formed of a second polymeric material that differs from the first material;
at least one optical fiber positioned within the at least one buffer tube in a loose configurations;
a strengthening layer that circumferentially overlies the second layer; and
a polymeric jacket that circumferentially overlies the strength layer.

21. (canceled)

22. The fiber optic cable defined in claim 20, wherein the first material has a first coefficient of thermal expansion, and the second material has a second coefficient of thermal expansion that differs from the first coefficient of thermal expansion.

23. The fiber optic cable defined in claim 20, wherein the second layer is the outermost layer of the buffer tube.

24. The fiber optic cable defined in claim 20, further comprising a third layer that circumferentially surrounds the second layer and is formed of a third material.

25. (canceled)

26. (canceled)

27. (canceled)

28. (canceled)

29. (canceled)
